(19) United States
(12) Patent Application Publication
(10) Pub. No.: US 2025/0321097 A1
(43) Pub. Date: Oct. 16, 2025

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventor: Kousuke NOGAMI, Tokyo (JP)

(73) Assignee: NEC Corporation, Minato-ku, Tokyo (JP)

(21) Appl. No.: 18/865,406

(22) PCT Filed: May 23, 2022
(86) PCT No.: PCT/JP2022/021095

§ 371 Date: Nov. 13, 2024

(51) Int. Cl. G01B 21/16; G01P 15/18

(52) U.S. Cl. CPC G01B 21/16; G01P 15/18

(57) ABSTRACT

In order to attain an object of more accurately estimate a posture of a mobile object in a three-dimensional space, an information processing apparatus (1) includes: an acquisition section (11) for acquiring a three-dimensional model of the mobile object; and a specifying section (12) for specifying, with reference to the three-dimensional model, a plurality of measurement point candidates necessary for estimation of the posture of the mobile object.

### TECHNICAL FIELD

The present invention relates to a technology for estimating a posture of a mobile object.

### BACKGROUND ART

Patent Literature 1 discloses a technology for estimating a posture of a mobile object with use of a parameter detected with use of a sensor included in the mobile object.

### CITATION LIST

### Patent Literature

### [Patent Literature 1]

Japanese Patent Application Publication Tokukaihei No. 2021-21673

### SUMMARY OF INVENTION

### Technical Problem

In a case where a surface on which the mobile object is placed is a non-two-dimensional surface because, for example, the surface includes an inclined surface, a low-lying depression, or the like, it is necessary to accurately estimate a posture of the mobile object in a three-dimensional space. According to the technology disclosed in Patent Literature 1, in a case where, for example, the mobile object includes a 6-axis sensor, it is not possible to accurately detect a yaw angle. This makes it difficult to accurately estimate the posture in the three-dimensional space. Further, in a case where, for example, the mobile object includes a 9-axis sensor, it is necessary to measure a difference between Earth's axis and a site coordinate system. This complicates a process for accurately estimate the posture in the three-dimensional space.

An example aspect of the present invention has been made in view of the above problems, and an example object thereof is to provide a technology for more accurately estimating a posture of a mobile object in a three-dimensional space.

### Solution to Problem

An information processing apparatus in accordance with an example aspect of the present invention includes: an acquisition means for acquiring a three-dimensional model of a mobile object; and a specifying means for specifying, with reference to the three-dimensional model, a plurality of measurement point candidates necessary for estimation of a posture of the mobile object.

An information processing method in accordance with an example aspect of the present invention includes: acquiring a three-dimensional model of a mobile object; and specifying, with reference to the three-dimensional model, a plurality of measurement point candidates necessary for estimation of a posture of the mobile object.

A storage medium in accordance with an example aspect of the present invention stores therein a program for causing a computer to function as an information processing apparatus, the program causing the computer to function as: an acquisition means for acquiring a three-dimensional model of a mobile object; and a specifying means for specifying, with reference to the three-dimensional model, a plurality of measurement point candidates necessary for estimation of a posture of the mobile object. The program is encompassed within an example aspect of the present invention.

### Advantageous Effects of Invention

According to an example aspect of the present invention, it is possible to more accurately estimate a posture of a mobile object in a three-dimensional space.

### BRIEF DESCRIPTION OF DRAWINGS

FIG. 1 is a block diagram illustrating a configuration of an information processing apparatus in accordance with a first example embodiment.

FIG. 2 is a flowchart illustrating a flow of an information processing method in accordance with the first example embodiment.

FIG. 3 is a block diagram illustrating a configuration of an information processing apparatus in accordance with a second example embodiment.

FIG. 4 is a schematic view illustrating a specific example of a three-dimensional model in the second example embodiment.

FIG. 5 is a schematic view illustrating an example of coordinate axis information in the second example embodiment.

FIG. 6 is a flowchart illustrating a flow of an information processing method in accordance with the second example embodiment.

FIG. 7 is a schematic view illustrating a specific example of a specifying process and an extraction process in the second example embodiment.

FIG. 8 is a schematic view illustrating a specific example of the extraction process in the second example embodiment.

FIG. 9 is a view illustrating a specific example of data for display in the second example embodiment.

FIG. 10 is a view illustrating a specific example of a display screen in the second example embodiment.

FIG. 11 is a block diagram illustrating a configuration of an information processing apparatus in accordance with a third example embodiment.

FIG. 12 is a flowchart illustrating a flow of an information processing method in accordance with the third example embodiment.

FIG. 13 is a schematic view illustrating an outline of a specific example of an estimation process in the third example embodiment.

FIG. 14 is a view schematically illustrating details of the specific example of the estimation process in the third example embodiment.

FIG. 15 is a block diagram illustrating an example hardware configuration of each of the information processing apparatuses in accordance with the example embodiments.

### EXAMPLE EMBODIMENTS

### First Example Embodiment

The following description will discuss a first example embodiment of the present invention in detail with reference to drawings. The present example embodiment is a basic form of example embodiments described later.

### <Configuration of Information Processing Apparatus 1>

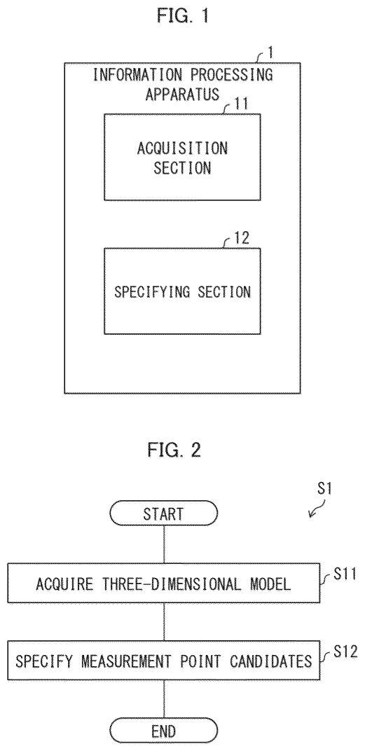

The following will discuss, with reference to FIG. 1, a configuration of an information processing apparatus 1 in accordance with the present example embodiment. FIG. 1 is a block diagram illustrating a configuration of the information processing apparatus 1.

As illustrated in FIG. 1, the information processing apparatus 1 includes an acquisition section 11 and a specifying section 12. The acquisition section 11 acquires a three-dimensional model of a mobile object. The specifying section 12 specifies, with reference to the three-dimensional model, a plurality of measurement point candidates necessary for estimation of a posture of the mobile object.

### <Flow of Information Processing Method S1>

The information processing apparatus 1 configured as described above carries out an information processing method S1 in accordance with the present example embodiment. The following description will discuss a flow of the information processing method S1 with reference to FIG. 2. FIG. 2 is a flowchart illustrating a flow of the information processing method S1.

As illustrated in FIG. 2, the information processing method S1 includes steps S11 and S12. In step S11, the acquisition section 11 acquires a three-dimensional model of a mobile object. In step S12, the specifying section 12 specifies, with reference to the three-dimensional model, a plurality of measurement point candidates necessary for estimation of a posture of the mobile object.

### <Program Implementation Example>

In a case where the information processing apparatus 1 is constituted by a computer, the following program is stored in a memory (storage medium) referred to by the computer. The program is a program for causing a computer to function as the information processing apparatus 1, the program causing the computer to function as: the acquisition section 11 that acquires a three-dimensional model of a mobile object; and a specifying section 12 that specifies, with reference to the three-dimensional model, a plurality of measurement point candidates necessary for estimation of a posture of the mobile object.

The information processing method S1 described above is realized by the computer reading the program from the memory and executing the program.

### <Example Advantage of the Present Example Embodiment>

As described above, the present example embodiment employs the configuration of: acquiring a three-dimensional model of a mobile object; and specifying, with reference to the three-dimensional model, a plurality of measurement point candidates necessary for estimation of a posture of the mobile object. The plurality of measurement point candidates can be used for more accurate estimation of the posture of the mobile object in a three-dimensional space. It is thus possible to more accurately estimate the posture of the mobile object in the three-dimensional space.

### Second Example Embodiment

The following description will discuss a second example embodiment of the present invention in detail with reference to drawings. The same reference numerals will be given to constituent elements having the same functions as those described in the first example embodiment, and descriptions of such constituent elements will be omitted as appropriate.

### <Overview of Information Processing Apparatus 1A>

An information processing apparatus 1A in accordance with the present example embodiment is an apparatus which presents a measurement point with respect to which an external measurement apparatus TS should carry out measurement in order to estimate a posture of heavy equipment MV. The heavy equipment MV is an example of a mobile object in accordance with each of the example embodiments of the present application.

For example, a user operates the external measurement apparatus TS to carry out measurement with respect to the measurement point presented by the information processing apparatus 1A. Further, in a case where the heavy equipment MV includes a posture sensor, the user corrects a measured value of the posture sensor with use of a result of the measurement carried out by the external measurement apparatus TS. The posture sensor may be, but is not limited to, for example, a 6-axis sensor (internal measurement unit: IMU) which measures a three-dimensional angular velocity and a three-dimensional acceleration. The external measurement apparatus TS may be, but is not limited to, for example, a total station which measures a distance to and an angle of a measurement point.

### <Configuration of Information Processing Apparatus 1A>

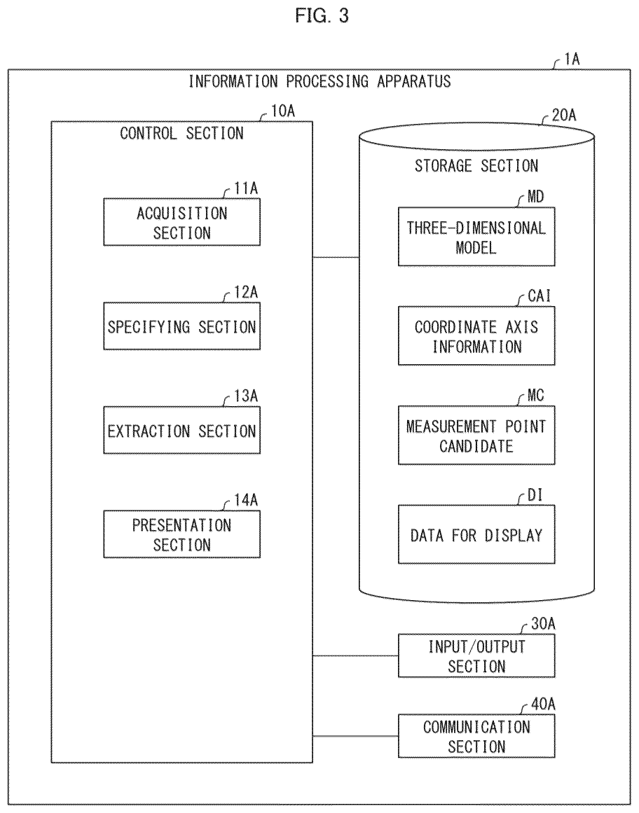

The following will discuss, with reference to FIG. 3, a configuration of the information processing apparatus 1A in accordance with the present example embodiment. FIG. 3 is a block diagram illustrating a configuration of the information processing apparatus 1A. As illustrated in FIG. 3, the information processing apparatus 1A includes a control section 10A, a storage section 20A, an input/output section 30A, and a communication section 40A. The input/output section 30A receives input to the information processing apparatus 1A, via an input apparatus (not illustrated) such as a mouse and a touchpad. The input/output section 30A also outputs, to a display apparatus (not illustrated) such as a liquid crystal display, information to be outputted from the information processing apparatus 1A. Note that the input/output section 30A may be connected to an apparatus, such as a touch panel, into which an input apparatus and an output apparatus has been integrally formed. The communication section 40A carries out communications with another apparatus via a network.

The control section 10A collectively controls sections of the information processing apparatus 1A. The control section 10A includes an acquisition section 11A, a specifying section 12A, an extraction section 13A, and a presentation section 14A. The acquisition section 11A and the specifying section 12A are configured to be similar to the acquisition section 11 and the specifying section 12 in the first example embodiment, but details of the acquisition section 11A and the specifying section 12A differ from those of the acquisition section 11 and the specifying section 12. The “extraction means” recited in claims may be realized by the extraction section 13A, but the “extraction means” is not limited thereto. The “presentation means” recited in the claims may be realized by the presentation section 14A, but the “presentation means” is not limited thereto. The sections included in the control section 10A will be discussed in detail in “Flow of information processing method S1A” (described later).

The storage section 20A stores therein various data used by the control section 10A. For example, the storage section 20A stores therein a three-dimensional model MD, coordinate axis information CAI, measurement point candidates MC, and data DI for display. For example, the three-dimensional model MD and the coordinate axis information CAI are stored in advance in the storage section 20A. For example, the measurement point candidates MC and the data DI for display are generated in “Flow of information processing method S1A” (described later).

### (Three-Dimensional Model MD)

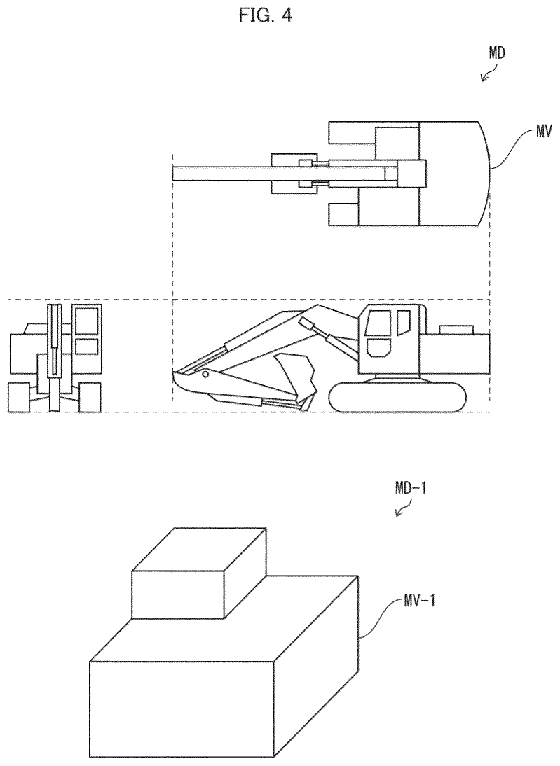

The following description will discuss an example of the three-dimensional model MD with reference to FIG. 4. FIG. 4 is a schematic view illustrating a specific example of the three-dimensional model MD of the heavy equipment MV. As illustrated in FIG. 4, the three-dimensional model MD is data that represents a three-dimensional shape of the heavy equipment MV illustrated in a 3-view drawing. Hereinafter, for easy explanation, it may be assumed that the three-dimensional shape of the heavy equipment MV is a solid figure MV-1 illustrated in FIG. 4. In this case, the heavy equipment MV, whose three-dimensional shape is the solid figure MV-1, and the three-dimensional model MD of the heavy equipment MV are also referred to as heavy equipment MV-1 and a three-dimensional model MD-1, respectively. In a case where it is not necessary to distinguish between the heavy equipment MV and the heavy equipment MV-1 or between the three-dimensional model MD and the three-dimensional model MD-1, the terms “heavy equipment MV” and “three-dimensional model MD” will simply be used. The three-dimensional model MD is represented, for example, by computer aided design (CAD) data or point cloud data, but the present example embodiment is not limited to this.

### (Coordinate Axis Information CAI)

The coordinate axis information CAI is information that indicates a relationship between an axis of a site coordinate system and a posture of the heavy equipment MV. The site coordinate system is an orthogonal coordinate system that is used in measurement in which a measurement point is used. The site coordinate system is determined in accordance with a surface on which the heavy equipment MV is provided at a site. For example, the site coordinate system may be an orthogonal coordinate system whose xy plane is an approximation of the surface at the site. In this case, the coordinate axis information CAI may be information in which the three-dimensional model MD provided on the xy plane is represented with use of the site coordinate system. Note that the three-dimensional model MD is provided on the xy plane so as to represent the heavy equipment MV in a vertical condition. The vertical condition means a state in which the heavy equipment MV is placed without inclination.

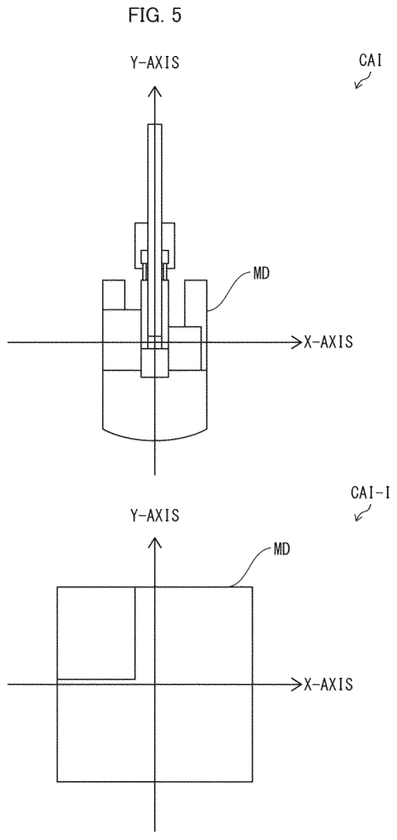

The following description will discuss an example of the coordinate axis information CAI with reference to FIG. 5. FIG. 5 is a schematic view illustrating an example of the coordinate axis information CAI, and is a top view of the three-dimensional model MD as viewed in a positive z-axis direction of the site coordinate system. In the coordinate axis information CAI, the three-dimensional model MD is provided on the xy plane in a vertical condition. Further, coordinate axis information CAI-1 indicates a relationship between the three-dimensional model MD-1 and the site coordinate system. In the coordinate axis information CAI-1, the three-dimensional model MD-1 is provided on the xy plane in a vertical condition.

### <Flow of Information Processing Method S1A>

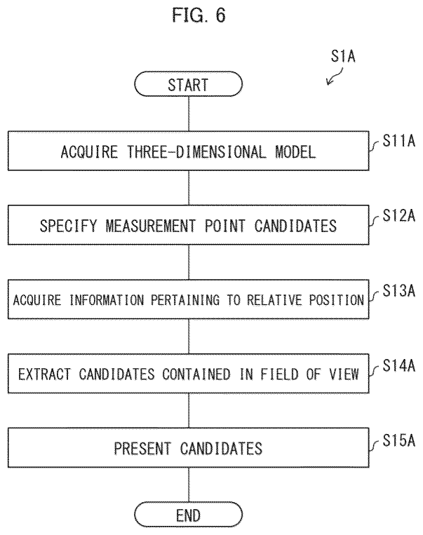

The information processing apparatus 1A configured as described above carries out an information processing method S1A in accordance with the present example embodiment. The following description will discuss a flow of the information processing method S1A with reference to FIG. 6. FIG. 6 is a flowchart illustrating a flow of the information processing method S1A. As illustrated in FIG. 6, the information processing method S1A includes steps S11A to S15A.

### (Step S11A)

In step S11A, the acquisition section 11A acquires the three-dimensional model MD of the heavy equipment MV (mobile object). In the present example embodiment, the acquisition section 11A acquires the three-dimensional model MD by reading the three-dimensional model MD from the storage section 20A. Note that the acquisition section 11A may also acquire the three-dimensional model MD via the input/output section 30A or the communication section 40A.

### (Step S12A)

In step S12A, the specifying section 12A specifies, with reference to the three-dimensional model MD of the heavy equipment MV (mobile object), a plurality of measurement point candidates necessary for estimation of a posture of the heavy equipment MV. For example, the specifying section 12A may specify a candidate for a measurement reference line segment, which candidate is necessary for the estimation of the posture. Note that specifying a candidate for a measurement reference line segment is substantially synonymous with specifying at least “a plurality of measurement point candidates” located at both ends of the candidate for a measurement reference line segment. Further, for example, the specifying section 12A may further refer to the coordinate axis information CAI and specify a pair of measurement point candidates that are provided parallel to any one of the axes of the site coordinate system.

### (Specific Example of Specifying Process)

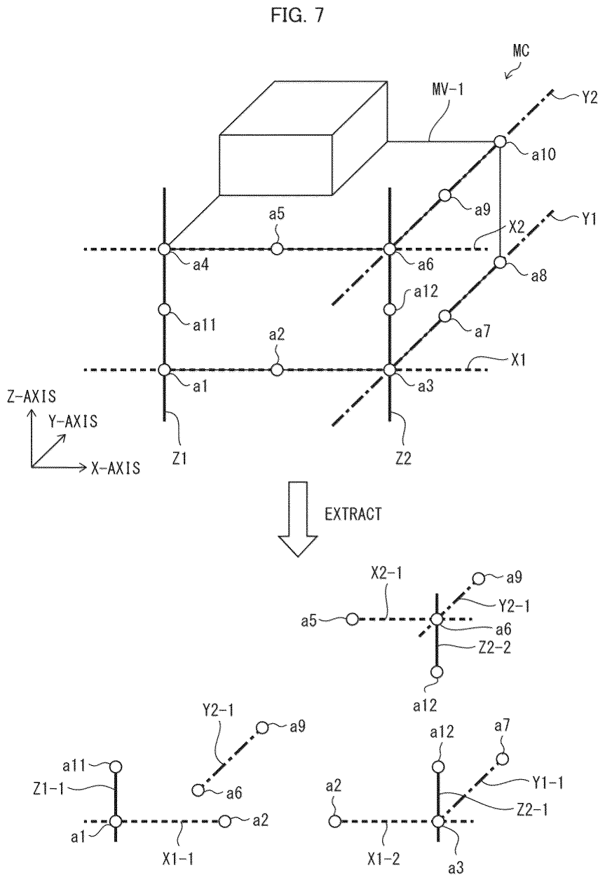

The following description will discuss, with reference to FIG. 7, a specific example of a specifying process of specifying a plurality of measurement point candidates. FIG. 7 is a schematic view illustrating a specific example of the specifying process and an extraction process (described later). As illustrated in FIG. 7, the specifying section 12A specifies, with reference to the three-dimensional model MD-1, measurement point candidates MC (points a1 to a12) as the plurality of measurement point candidates. These points a1 to a12 (the plurality of measurement point candidates) include a pair of measurement point candidates that are provided parallel to at least one of the axes of the site coordinate system (orthogonal coordinate system) in a case where the heavy equipment MV-1 (mobile object) is in a vertical condition in the site coordinate system.

For example, the points a1 and a2 are a pair provided parallel to an x-axis of the site coordinate system. The points a1 and a2 are contained in a line segment X1 parallel to the x-axis. Further, as illustrated in FIG. 7, the measurement point candidates MC include pairs of measurement point candidates contained in line segments X1, X2, Y1, Y2, Z1, and Z2 parallel to any one of the x-axis, the y-axis, and the z-axis. In other words, the specifying section 12A specifies the line segments X1, X2, Y1, Y2, Z1, and Z2, which are candidates for a measurement reference line segment parallel to at least one of the axes of the site coordinate system.

For example, since the line segment X1 is parallel to the x-axis, respective sets of measured coordinates of the points a1 and a2, which are contained in the line segment X1, are supposed to be equal to each other in terms of a y-coordinate and a z-coordinate, in a case where the heavy equipment MV-1 is in a vertical condition. As such, it is possible to carry out an estimation process of estimating a posture of the heavy equipment MV on the basis of a difference between the respective sets of measured coordinates of the points a1 and a2. Thus, respective sets of measured coordinates of a plurality of measurement points contained in a measurement reference line segment parallel to at least one of the axes of the site coordinate system can be used for the estimation process of estimating a posture of the heavy equipment MV.

### (Step S13A)

In step S13A, the acquisition section 11A acquires information pertaining to a relative position of the heavy equipment MV (mobile object) with respect to the external measurement apparatus TS. For example, the information pertaining to the relative position includes information indicative of a position and an orientation of the heavy equipment MV as determined with respect to the direction of a line of sight of the external measurement apparatus TS. Further, the information pertaining to the relative position includes information pertaining to a viewing angle of the external measurement apparatus TS. Note that the acquisition section 11A may acquire the information pertaining to the relative position by referring to output from the external measurement apparatus TS, an external camera (not illustrated), or the like. Note here that the direction of the line of sight of the external measurement apparatus TS means, for example, a direction in which a sensor of the external measurement apparatus TS faces. The information indicative of a viewing angle is, for example, information indicative of an area that can be sensed by the sensor.

### (Step S14A)

In step S14A, the extraction section 13A extracts, from the plurality of measurement point candidates with reference to the information pertaining to the relative position, a plurality of measurement point candidates that are contained in a measurement-possible area with respect to which the external measurement apparatus TS is capable of carrying out measurement. For example, the extraction section 13A refers to information indicative of the direction of the line of sight of the external measurement apparatus TS and the viewing angle of the external measurement apparatus TS, which information is included in the information pertaining to the relative position, and specifies a region that is the measurement-possible area with respect to which the external measurement apparatus TS is capable of carrying out measurement. Further, the extraction section 13A refers to the position and the orientation of the heavy equipment MV included in the information pertaining to the relative position, which position and orientation are determined with respect to the direction of the line of sight, and narrows down the plurality of measurement point candidates to a plurality of measurement point candidates that are contained in the measurement-possible area. Note that the measurement-possible area with respect to which the external measurement apparatus TS is capable of carrying out measurement can also be considered to be a stretch of space with respect to which an optical system (not illustrated) of the external measurement apparatus TS is capable of carrying out measurement. The measurement-possible area may be expressed, for example, as “field of view”, “angle of view”, or the like. Hereinafter, the measurement-possible area is also referred to as “field of view”.

### Specific Example 1 of Extraction Process

The following description will discuss, with reference to FIG. 7, a specific example 1 of an extraction process of extracting a plurality of measurement point candidates. In the example illustrated in FIG. 7, the measurement point candidates MC (points a1 to a12) are specified with respect to the heavy equipment MV-1. In this example, the points a1, a2, a3, a5, a6, a7, a9, a11, and a12 are within the field of view of the external measurement apparatus TS. The points a4, a8, and a10 are out of the field of view. The extraction section 13A therefore extracts these points that are within the field of view, thereby extracting line segments X1-1, X1-2, X2-1, Y1-1, Y2-1, Z1-1, Z2-1, and Z2-2 as candidates for a measurement reference line segment. The line segments X1-1 and X1-2 are part of the line segment X1. The line segment X2-1 is part of the line segment X2. The line segment Y1-1 is part of the line segment Y1. The line segment Y2-1 is part of the line segment Y2. The line segment Z1-1 is part of the line segment Z1. The line segments Z2-1 and X2-2 are part of the line segment Z2. In other words, the extraction section 13A extracts, from the candidates for a measurement reference line segment with reference to the information pertaining to the relative position described above, a whole or part of candidates that are contained in the field of view of the external measurement apparatus TS.

### Specific Example 2 of Extraction Process

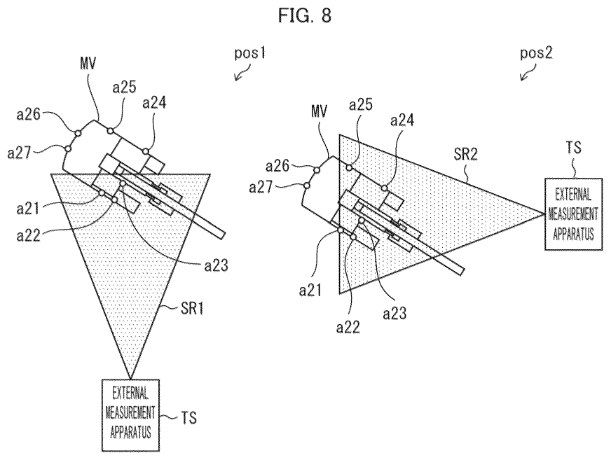

The following description will discuss, with reference to FIG. 8, a specific example 2 of the extraction process of extracting a plurality of measurement point candidates. FIG. 8 is a schematic view illustrating the specific example 2 of the extraction process. In this example, measurement point candidates MC (points a21 to a27) are specified with respect to the heavy equipment MV. In FIG. 8, relative positions pos1 and pos2 each show a relative position of the heavy equipment MV with respect to the external measurement apparatus TS. Although FIG. 8 shows the relative positions pos1 and pos2 two-dimensionally, it is preferable that information indicative of the relative positions pos1 and pos2 each indicate a three-dimensional relative position.

As illustrated in FIG. 8, the extraction section 13A specifies a field of view SR1 on the basis of the information pertaining to the relative position pos1. The field of view SR1 is a conical region whose apex corresponds to a position of the external measurement apparatus TS. In this case, the extraction section 13A extracts the points a21 to a23, which are contained in the field of view SR1. In other words, the extraction section 13A extracts a measurement reference line segment that contains the dots a21 and a22 contained in the field of view SR1 and a measurement reference line segment that contains the dots a22 and a23 contained in the field of view SR1. The extraction section 13A does not extract the dots a24 to a27, which are not contained in the field of view SR1. In other words, the extraction section 13A extracts neither a measurement reference line segment that contains the dots a24 and a25, which are not contained in the field of view SR1, nor a measurement reference line segment that contains the dots a26 and a27, which are not contained in the field of view SR1.

The extraction section 13A also specifies a field of view SR2 on the basis of the information pertaining to the relative position pos2. The field of view SR2 is a conical region whose apex corresponds to the external measurement apparatus TS. In this case, the extraction section 13A extracts the points a21 to a25, which are contained in the field of view SR2. In other words, the extraction section 13A extracts the measurement reference line segment that contains the dots a21 and a22 contained in the field of view SR2, the measurement reference line segment that contains the dots a22 and a23 contained in the field of view SR2, and the measurement reference line segment that contains the dots a24 and a25 contained in the field of view SR2. The extraction section 13A does not extract the dots a26 and a27, which are not contained in the field of view SR2. In other words, the extraction section 13A does not extract the measurement reference line segment that contains the dots a26 and a27, which are not contained in the field of view SR2.

### (Step S15A)

In step S15A, the presentation section 14A presents at least one selected from the group consisting of: the plurality of measurement point candidates specified by the specifying section 12A; and the plurality of measurement point candidates extracted by the extraction section 13A. For example, the presentation section 14A may present a candidate for a measurement reference line segment which candidate contains at least two of the plurality of measurement points specified by the specifying section 12A. Further, for example, the presentation section 14A may present a candidate for a measurement reference line segment which candidate contains at least two of the plurality of measurement points extracted by the extraction section 13A. The following description will discuss an example in which the presentation section 14A (i) generates data DI for display for displaying a plurality of measurement point candidates (or a plurality of candidates for a measurement reference line segment) on the display apparatus and (ii) outputs the data DI for display to the display apparatus.

### (Specific Example of Display Screen)

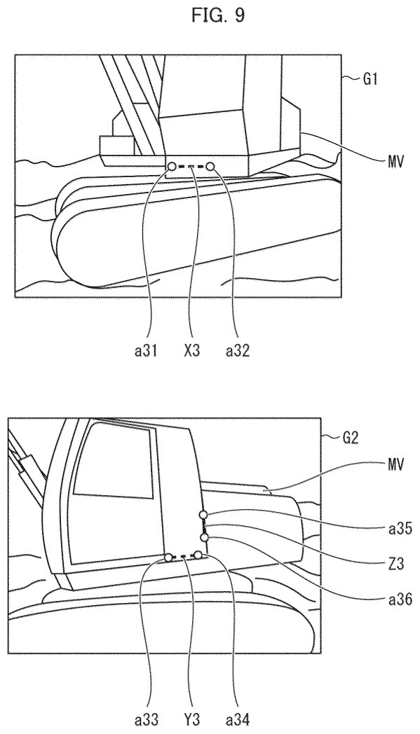

The following description will discuss, with reference to FIG. 9, a specific example of a display screen in which the data DI for display is presented.

FIG. 9 is a view illustrating example display screens G1 and G2. As illustrated in FIG. 9, data DI for display presented in the example display screen G1 includes: a captured image containing the heavy equipment MV; points a31 and a32; and a line segment X3. The captured image is an image obtained by photographing the heavy equipment MV in operation. The captured image is captured, for example, by a camera (not illustrated) positioned so as to contain the heavy equipment MV in operation within an angle of view. The points a31 and a32 represent a plurality of measurement point candidates extracted by the extraction section 13A. The line segment X3 contains the points a31 and a32 and is parallel to the X-axis of the site coordinate system.

Data DI for display presented in the example display screen G2 contains: a captured image containing the heavy equipment MV; points a33, a34, a35, and a36; and line segments Y3 and Z3. The points a33, a34, a35, and a36 represent a plurality of measurement point candidates extracted by the extraction section 13A. The line segment Y3 contains the points a33 and a34 and is parallel to the y-axis of the site coordinate system. The line segment Z3 contains the points a35 and a36 and is parallel to the z-axis of the site coordinate system.

Thus, the presentation section 14A presents a plurality of measurement point candidates (or a measurement reference line segment(s)) in accordance with a relative position of the heavy equipment MV with respect to the external measurement apparatus TS. This is the end of the description of the information processing method S1A.

### <Example Advantage of the Present Example Embodiment>

As described above, the present example embodiment employs, in addition to the configuration in accordance with the first example embodiment, the configuration of: acquiring information pertaining to a relative position of the heavy equipment MV (mobile object) with respect to the external measurement apparatus TS; and extracting, from the plurality of measurement point candidates with reference to the information pertaining to the relative position, a plurality of measurement point candidates that are contained in a field of view of the external measurement apparatus TS.

As such, the present example embodiment makes it possible to accurately specify, in accordance with the relative position, a plurality of measurement point candidates which are on the heavy equipment MV and with respect to which measurement is to be carried out with use of the external measurement apparatus TS in order to estimate a posture of the heavy equipment MV (mobile object).

Further, the present example embodiment employs the configuration of presenting at least one selected from the group consisting of: the plurality of measurement point candidates specified by the specifying section 12A; and the plurality of measurement point candidates extracted by the extraction section 13A.

As such, according to the present example embodiment, a user is able to carry out measurement with respect to the presented measurement point candidates with use of the external measurement apparatus TS.

Further, the present example embodiment employs a configuration in which the plurality of measurement point candidates include a pair of measurement point candidates that are provided parallel to at least one of the axes of the site coordinate system (orthogonal coordinate system) in a case where the heavy equipment MV (mobile object) is in a vertical condition in the site coordinate system.

Note here that respective sets of measured coordinates of the pair of measurement points are supposed to be equal to each other in terms of a coordinate(s) other than a component(s) parallel to the at least one of the axes, in a case where the heavy equipment MV is in a vertical condition. With use of this, it is possible to accurately carry out an estimation process on the basis of a difference between the respective sets of measured coordinates of the pair of measurement points. As such, by carrying out measurement with use of a plurality of measurement point candidates presented in the present example embodiment, it is possible to accurately estimate a posture of the heavy equipment MV. Further, by carrying out measurement with use of a plurality of measurement point candidates presented in the present example embodiment, it is possible to accurately correct a value detected by the posture sensor included in the heavy equipment MV.

### [Variation 1]

The present example embodiment can be modified into an example aspect in which a user carries out a simulation in which the checks measurement point candidates while changing the relative position of the heavy equipment MV with respect to the external measurement apparatus TS on the display screen.

In the present variation, the information processing apparatus 1A repeats the processes of steps S13A to S15A after carrying out the steps S11A and S12A.

In step S13A, the acquisition section 11A acquires information pertaining to a relative position of the heavy equipment MV with respect to the external measurement apparatus TS in a virtual space, instead of acquiring information pertaining to a relative position of the heavy equipment MV with respect to the external measurement apparatus TS in the real space.

Further, in step S15A, the presentation section 14A displays data DI for display including the virtual space, instead of displaying data DI for display including a captured image of the heavy equipment MV. In the virtual space, an object representing the heavy equipment MV and an object representing the external measurement apparatus TS are provided. The data DI for display includes a first graphical user interface and a second graphical user interface. The first graphical user interface receives user input related to a position of the heavy equipment MV (mobile object). The second graphical user interface receives user input related to a position of the external measurement apparatus TS. The user operates the first graphical user interface and the second graphical user interface to thereby cause a change in the relative position in the virtual space.

### (Specific Example of Display Screen)

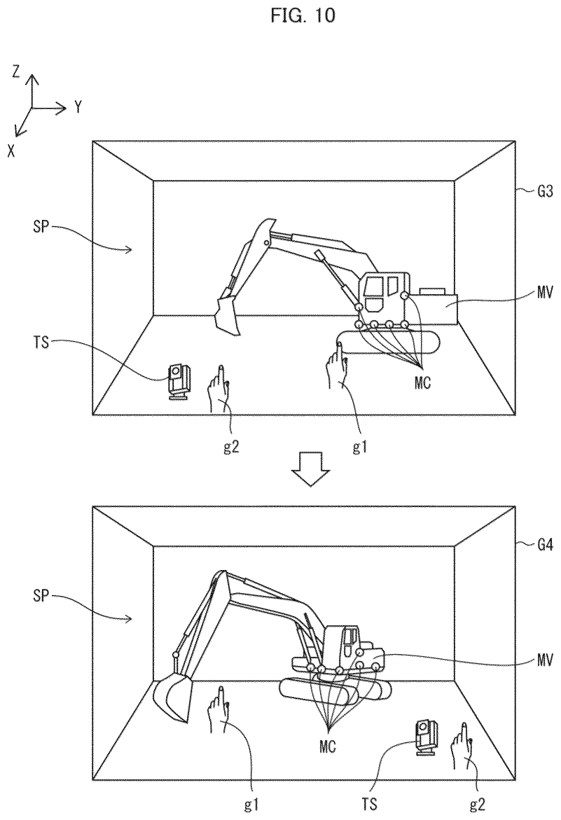

The following description will discuss, with reference to FIG. 10, a specific example of a display screen in which such data DI for display is presented. FIG. 10 is a view illustrating example display screens G3 and G4. As illustrated in FIG. 10, data DI for display presented in the example display screen G3 includes: an image indicating a virtual space SP; and GUI objects g1 and g2.

In the virtual space SP, an object representing the heavy equipment MV, objects representing a plurality of measurement point candidates MC, and an object representing the external measurement apparatus TS are provided. The GUI object g1 is an example of the first graphical user interface. The GUI object g2 is an example of the second graphical user interface.

For example, the control section 10A updates, in accordance with user input, a position and an orientation of the object representing the heavy equipment MV in the virtual space SP, by moving the GUI object g1 while placing the GUI object g1 over the object representing the heavy equipment MV (i.e., by dragging the GUI object g1). Further, for example, the control section 10A updates, in accordance with user input, a position and an orientation of the object representing the external measurement apparatus TS in the virtual space SP, by moving the GUI object g2 while placing the GUI object g2 over the object representing the external measurement apparatus TS (i.e., by dragging the GUI object g2). In this manner, the relative position of the heavy equipment MV with respect to the external measurement apparatus TS in the virtual space SP is changed.

Thus, according to the present variation, in a case where the user has virtually changed a relative position of the external measurement apparatus TS with respect to the heavy equipment MV, the user is able to be aware of a change of measurement point candidates.

### [Variation 2]

The present example embodiment has been described on the assumption that the presentation section 14A presents a plurality of measurement point candidates by outputting the data DI for display to the display apparatus. The present example embodiment is not limited to this, and the presentation section 14A may generate audio data DI that indicates at least one selected from the group consisting of: a plurality of measurement point candidates specified by the specifying section 12A; and a plurality of measurement point candidates extracted by the extraction section 13A. In this case, the presentation section 14A may present a plurality of measurement point candidates by outputting the audio data DI to an audio output apparatus.

### Third Example Embodiment

The following description will discuss a third example embodiment of the present invention in detail with reference to drawings. The same reference numerals will be given to constituent elements having the same functions as those described in the first and second example embodiments, and descriptions of such constituent elements will not be repeated.

### <Overview of Information Processing Apparatus 1B>

An information processing apparatus 1B in accordance with the present example embodiment is an apparatus which estimates a posture of heavy equipment MV by correcting, with use of a result of measurement carried out with use of an external measurement apparatus TS, a value detected by a posture sensor included in the heavy equipment MV.

### <Configuration of Information Processing Apparatus 1B>

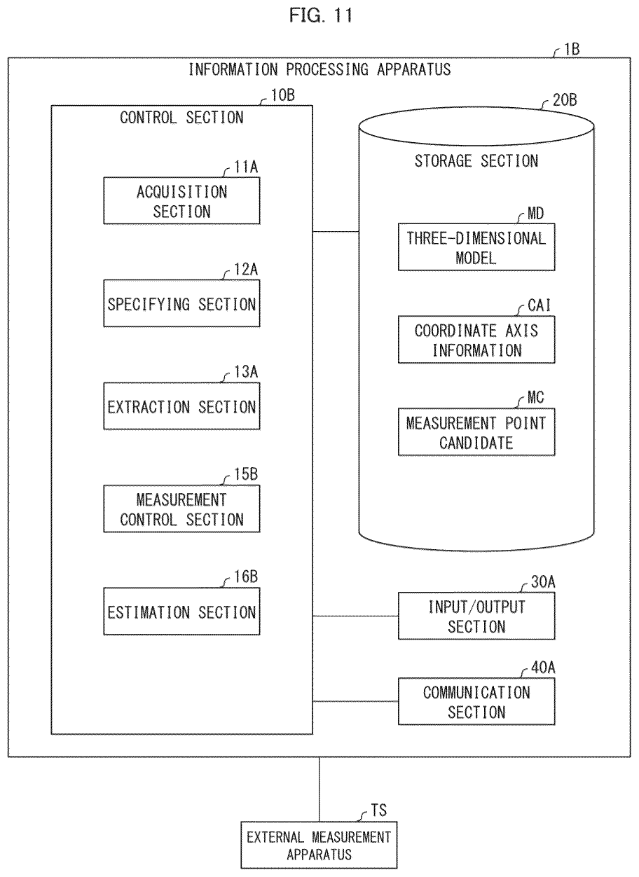

The following will discuss, with reference to FIG. 11, a configuration of the information processing apparatus 1B in accordance with the present example embodiment. FIG. 11 is a block diagram illustrating a configuration of the information processing apparatus 1B. As illustrated in FIG. 11, the information processing apparatus 1B includes a control section 10B, a storage section 20B, an input/output section 30A, and a communication section 40A. The input/output section 30A and the communication section 40A are as described in the second example embodiment. The information processing apparatus 1B is communicatively connected to the external measurement apparatus TS. The external measurement apparatus TS is as described in the second example embodiment.

The control section 10B includes an acquisition section 11A, a specifying section 12A, an extraction section 13A, a measurement control section 15B, and an estimation section 16B. The acquisition section 11A, the specifying section 12A, and the extraction section 13A are as described in the second example embodiment. The measurement control section 15B controls the external measurement apparatus TS. The “measurement means” recited in the claims may be realized by the measurement control section 15B, but the “measurement means” is not limited thereto. The “estimation means” recited in the claims may be realized by the estimation section 16B, but the “estimation means” is not limited thereto. The sections included in the control section 10B will be discussed in detail in “Flow of information processing method S1B” below.

The storage section 20B stores therein a three-dimensional model MD, coordinate axis information CAI, and measurement point candidates MC. Details of these pieces of data are as described in the second example embodiment. Note that, in the present example embodiment, the measurement point candidates MC as well as the three-dimensional model MD and the coordinate axis information CAI are stored in advance in the storage section 20B. The measurement point candidates MC are generated by similar processes as those in steps S11A and S12A in the second example embodiment. On the heavy equipment MV, marker components that can be tracked by the external measurement apparatus TS are provided in advance at a plurality of measurement point candidates indicated by the measurement point candidates MC.

### <Flow of Information Processing Method S1B>

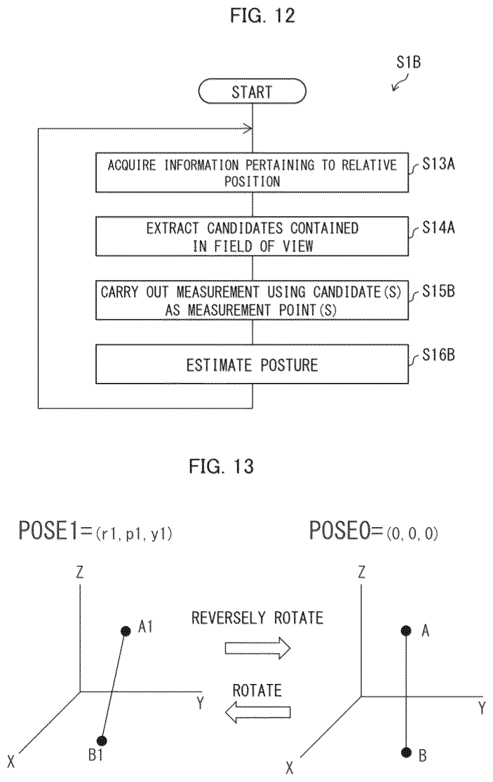

The information processing apparatus 1B configured as described above carries out an information processing method S1B in accordance with the present example embodiment. The following description will discuss a flow of the information processing method S1B with reference to FIG. 12. FIG. 12 is a flowchart illustrating a flow of the information processing method S1B. As illustrated in FIG. 12, the information processing method S1B includes steps S13A and S14A and steps S15B and S16B. Steps S13A and S14A are as described in the second example embodiment.

### (Step S15B)

In step S15B, the measurement control section 15B carries out measurement with use of, as a measurement point, at least one of a plurality of measurement point candidates which have been extracted by the extraction section 13A and which are contained in a field of view. Further, the measurement control section 15B may determine, with reference to heavy equipment information pertaining to the heavy equipment MV, measurement points with respect to which measurement is to be carried out, from among the plurality of measurement point candidates which have been extracted by the extraction section 13A and which are contained in the field of view.

For example, the measurement control section 15B controls the external measurement apparatus TS to measure, in a site coordinate system, coordinates of the measurement points with respect to which measurement is to be carried out. The measurement can be carried out with use of the above marker components provided at the plurality of measurement point candidates.

### (Step S16B)

In step S16B, the estimation section 16B estimates a posture of the heavy equipment MV (mobile object) with reference to a result of the measurement carried out by the measurement control section 15B.

For example, an estimation process of estimating the posture may be a process of estimating the posture of the heavy equipment MV on the basis of a difference between respective sets of measured coordinates of a pair of measurement point candidates. The pair of measurement point candidates is a plurality of points that are contained in a line segment parallel to at least one of the axes of the site coordinate system in a case where the heavy equipment MV is in a vertical condition.

### (Specific Example of Estimation Process)

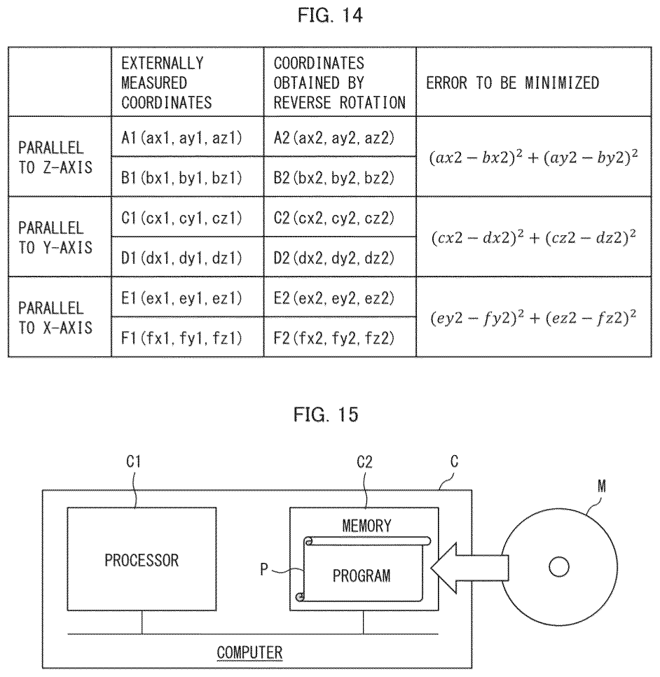

The following description will discuss a specific example of the estimation process with reference to FIGS. 13 and 14. FIG. 13 is a schematic view illustrating an overview of the specific example of the estimation process. FIG. 14 is a view illustrating details of the specific example of the estimation process.

In the example illustrated in FIG. 13, the measurement point candidates MC include points A and B. The points A and B are contained in a line segment parallel to a z-axis of the site coordinate system in a case where the heavy equipment MV is in a vertical condition. As such, coordinate values of the point A other than a z-axis component, that is, an x-coordinate and a y-coordinate of the point A are equal to those of the point B.

Here, the posture of the heavy equipment MV is indicated with use of a roll angle r, a pitch angle p, and a yaw angle y. For example, a posture of the heavy equipment MV in a case where the heavy equipment MV is in a vertical condition is indicated as POSE0(0,0,0), assuming that r, p, and y are each zero. A posture to be estimated of the heavy equipment MV is indicated as POSE1(r,p,y). In POSE1, points corresponding to the points A and B are indicated as points A1 and B1. Supposing that, for the points A1 and B1, measured coordinates (ax1,ay1,az1) and measured coordinates (bx1,by1,bz1) have been obtained, respectively.

The estimation process is a process of estimating POSE1 on the basis of the measured coordinates of the points A1 and B1. In a case where the posture of the heavy equipment MV changes from POSE0 to POSE1, a line segment A-B changes to a line segment A1-B1 by rotating. Further, the line segment A1-B1 returns to the line segment A-B by reversely rotating.

Note here that a rotation matrix R indicating a rotation of POSE0 to POSE1(r,p,y) can be expressed by the following expression (1).

$$\begin{matrix}R = R ( y ) R ( p ) R ( r ) \\ = ( \begin{matrix}cos y & - sin y & 0 \\ sin y & cos y & 0 \\ 0 & 0 & 1\end{matrix} ) ( \begin{matrix}cos p & 0 & sin p \\ 0 & 1 & 0 \\ - sin p & 0 & cos p\end{matrix} ) ( \begin{matrix}1 & 0 & 0 \\ 0 & cos r & - sin r \\ 0 & sin r & cos r\end{matrix} )\end{matrix} \qquad ( 1 )$$

Note that the expression (1) is an expression applicable to a case in which the roll angle r, the pitch angle p, and the yaw angle y are rotated in this order, and the rotation matrix R is not limited to this. Such an order of rotation is determined in accordance with the site coordinate system.

For example, it can be considered that the coordinates of the point A1 and the coordinates of the point B1 are calculated respectively by multiplying the coordinates of the point A and the coordinates of the point B by the rotation matrix R. As such, points A2 and B2 obtained respectively by multiplying the points A1 and B1 by an inverse matrix of the rotation matrix R are supposed to be contained in a line segment parallel to the z-axis, as with the original points A and B. As such, by calculating a rotation matrix R in which the points A2 and B2 are contained in a line segment parallel to the z-axis, it is possible to estimate POSE1(r,p,y).

As illustrated in FIG. 14, respective sets of coordinates of the points A2 and B2 which are obtained by reversely rotating the line segment A1-B1 are indicated as (ax2,ay2,az2) and (bx2,by2,bz2), respectively. Note that “reversely rotating” is, as described above, equal to multiplying an inverse matrix of the rotation matrix R. For example, the coordinates of the point A2 can be calculated by the following expression (2).

$${( ax 2 , ay 2 , az 2 )}^{T} = {R}^{- 1} {( ax 1 , ay 1 , az 1 )}^{T} \qquad ( 2 )$$

The coordinates (bx2,by2,bz2) can be similarly calculated. Now, on the basis of a difference between ax2 and bx2, which are coordinate values other than z-components, and a difference between ay2 and by2, which are coordinate values other than the z-components, an error that lies between the pair is calculated. In a case where the points A2 and B2 are contained in a line segment parallel to the z-axis, the error between the pair is supposed to be zero.

Similarly, supposing that a pair of points C and D contained in a line segment parallel to the y-axis has been specified. Supposing also that measured coordinates of points C1 and D1, which are measured with respect to the respective points C and D, are (cx1,cy1,cz1) and (dx1,dy1,dz1), respectively. In this case, respective sets of coordinates of points C2 and D2, which are obtained by reversely rotating a line segment C1-D1, are indicated as (cx2,cy2,cz2) and (dx2,dy2,dz2), respectively. At this time, on the basis of a difference between cx2 and dx2, which are coordinate values other than y-components, and a difference between cz2 and dz2, which are coordinate values other than the z-components, an error that lies between the pair is calculated. In a case where the points C2 and D2 are contained in a line segment parallel to the y-axis, the error between the pair is supposed to be zero.

Similarly, supposing that a pair of points E and F contained in a line segment parallel to the x-axis has been specified. Supposing also that measured coordinates of points E1 and F1, which are measured with respect to the respective points E and F, are (ex1,ey1,ez1) and (fx1,fy1,fz1), respectively. In this case, respective sets of coordinates of points E2 and F2, which are obtained by reversely rotating a line segment E1-F1, are indicated as (ex2,ey2,ez2) and (fx2,fy2,fz2), respectively. At this time, on the basis of a difference between ey2 and fy2, which are coordinate values other than x-components, and a difference between ez2 and fz2, which are coordinate values other than the x-components, an error that lies between the pair is calculated. In a case where the points E2 and F2 are contained in a line segment parallel to the x-axis, the error between the pair is supposed to be zero.

As such, by calculating a rotation matrix R that minimizes a total sum of the respective errors of the pairs, it is possible to estimate POSE1.

Further, the information processing apparatus 1B may repeatedly carry out the information processing method S1B. This enables real-time estimation of a change in posture of the heavy equipment MV. This is the end of the description of the information processing method S1B.

### <Example Advantage of the Present Example Embodiment>

As described above, the present example embodiment employs, in addition to the configuration in accordance with the second example embodiment, the configuration of: using the external measurement apparatus TS to carry out measurement with use of, as a measurement point, at least one of a plurality of measurement point candidates which are contained in a field of view.

This makes it possible to carry out, while reducing labor of the user, measurement with respect to measurement points to be used in order to accurately estimate a posture of the heavy equipment MV.

Further, the present example embodiment employs the configuration of estimating a posture of the heavy equipment MV with reference to a result of measurement carried out by the measurement control section 15B.

This enables accurate, real-time estimation of a posture of the heavy equipment MV by carrying out measurement point with respect to more appropriate measurement points, while reducing labor of the user.

### [Variation 3]

In the third example embodiment, the information processing apparatus 1B may have, in addition to the function of carrying out the information processing method S1B, a function of carrying out the information processing method S1A in accordance with the second example embodiment.

### [Variation 4]

The descriptions of the second and third example embodiments have discussed example cases in each of which the heavy equipment MV is applied as an example of the mobile object in accordance with each of the example embodiments of the present application, but it is also possible to apply other mobile objects. Specific examples of such a mobile object include a robot, a human, and the like, but the mobile object is not limited to these examples, provided that the mobile object is capable of undergoing a change in posture thereof.

### [Software Implementation Example]

Some or all of the functions of each of the information processing apparatuses 1, 1A, and 1B may be implemented by hardware such as an integrated circuit (IC chip), or may be alternatively implemented by software.

In the latter case, the information processing apparatuses 1, 1A, and 1B are implemented by, for example, a computer that executes instructions of a program that is software implementing the foregoing functions. FIG. 15 illustrates an example of such a computer (hereinafter, referred to as “computer C”). The computer C includes at least one processor C1 and at least one memory C2. The at least one memory C2 stores a program P for causing the computer C to operate as each of the information processing apparatuses 1, 1A, and 1B. In the computer C, the at least one processor C1 reads and executes the program P stored in the at least one memory C2, so that the functions of the information processing apparatuses 1, 1A, and 1B are realized.

The processor C1 can be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 can be, for example, a flash memory, a hard disk drive (HDD), a solid state drive (SSD), or a combination thereof.

Note that the computer C may further include a random access memory (RAM) in which the program P is loaded at the time of execution and in which various data are temporarily stored. The computer C may further include a communication interface for carrying out transmission and reception of data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can be transmitted via a transmission medium. The transmission medium may be, for example, a communication network, a broadcast wave, or the like. The computer C can acquire the program P also via the transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following supplementary notes.

### (Supplementary Note 1)

An information processing apparatus, including:
an acquisition means for acquiring a three-dimensional model of a mobile object; and
a specifying means for specifying, with reference to the three-dimensional model, a plurality of measurement point candidates necessary for estimation of a posture of the mobile object.

### (Supplementary Note 2)

The information processing apparatus described in supplementary note 1, wherein the acquisition means further acquires information pertaining to a relative position of the mobile object with respect to an external measurement apparatus,
the information processing apparatus further including an extraction means for extracting, from the plurality of measurement point candidates with reference to the information pertaining to the relative position, a plurality of measurement point candidates that are contained in a measurement-possible area with respect to which the external measurement apparatus is capable of carrying out measurement.

### (Supplementary Note 3)

The information processing apparatus described in supplementary note 2, further including a measurement means for carrying out measurement with use of, as a reference point, at least one of the plurality of measurement point candidates which have been extracted by the extraction means and which are contained in the measurement-possible area.

### (Supplementary Note 4)

The information processing apparatus described in supplementary note 3, further including an estimation means for estimating a posture of the mobile object with reference to a result of the measurement carried out by the measurement means.

### (Supplementary Note 5)

The information processing apparatus described in any one of supplementary notes 2 to 4, further including a presentation means for presenting at least one selected from the group consisting of:
the plurality of measurement point candidates specified by the specifying means; and
the plurality of measurement point candidates extracted by the extraction means.

### (Supplementary Note 6)

The information processing apparatus described in supplementary note 5, wherein: a display screen presented by the presentation means contains
a first graphical user interface that receives user input related to a position of the mobile object and
a second graphical user interface that receives user input related to a position of the external measurement apparatus; and
the acquisition means acquires the information pertaining to the relative position with reference to the user input received via the first graphical user interface and the user input received via the second graphical user interface.

### (Supplementary Note 7)

The information processing apparatus described in any one of supplementary notes 1 to 4, wherein the plurality of measurement point candidates specified by the specifying means include a pair of measurement point candidates that are provided parallel to at least one of axes of an orthogonal coordinate system in a case where the mobile object is in a vertical condition in the orthogonal coordinate system.

### (Supplementary Note 8)

An information processing method, including:
acquiring a three-dimensional model of a mobile object; and
specifying, with reference to the three-dimensional model, a plurality of measurement point candidates necessary for estimation of a posture of the mobile object.

### (Supplementary Note 9)

A storage medium storing therein a program for causing a computer to function as an information processing apparatus, the program causing the computer to function as:
an acquisition means for acquiring a three-dimensional model of a mobile object; and
a specifying means for specifying, with reference to the three-dimensional model, a plurality of measurement point candidates necessary for estimation of a posture of the mobile object.

### [Additional Remark 3]

The whole or part of the example embodiments disclosed above can also be expressed as follows.

An information processing apparatus, including at least one processor, the at least one processor carrying out:
an acquisition process of acquiring a three-dimensional model of a mobile object; and
a specifying process of specifying, with reference to the three-dimensional model, a plurality of measurement point candidates necessary for estimation of a posture of the mobile object.

Note that the information processing apparatus may further include a memory, which may store therein a program for causing the at least one processor to carry out the acquisition process and the specifying process. The program may be stored in a computer-readable non-transitory tangible storage medium.

### REFERENCE SIGNS LIST

1, 1A, 1B: Information processing apparatus
10A, 10B: Control section
11, 11A: Acquisition section
12, 12A: Specifying section
13A: Extraction section
14A: Presentation section
15B: Measurement control section
16B: Estimation section
20A, 20B: Storage section
30A: Input/output section
40A: Communication section
TS: External measurement apparatus
C1: Processor
C2: Memory

What is claimed is:

1. An information processing apparatus, comprising at least one processor, the at least one processor carrying out:
an acquisition process of acquiring a three-dimensional model of a mobile object; and
a specifying process of specifying, with reference to the three-dimensional model, a plurality of measurement point candidates necessary for estimation of a posture of the mobile object.

2. The information processing apparatus according to claim 1, wherein: in the acquisition process, the at least one processor further acquires information pertaining to a relative position of the mobile object with respect to an external measurement apparatus; and
the at least one processor further carries out an extraction process of extracting, from the plurality of measurement point candidates with reference to the information pertaining to the relative position, a plurality of measurement point candidates that are contained in a measurement-possible area with respect to which the external measurement apparatus is capable of carrying out measurement.

3. The information processing apparatus according to claim 2, wherein the at least one processor further carries out a measurement process of carrying out measurement with use of, as a reference point, at least one of the plurality of measurement point candidates which have been extracted by the extraction process and which are contained in the measurement-possible area.

4. The information processing apparatus according to claim 3, wherein the at least one processor further carries out an estimation process of estimating a posture of the mobile object with reference to a result of the measurement carried out by the measurement process.

5. The information processing apparatus according to claim 2, wherein the at least one processor further carries out a presentationmeans process of presenting at least one selected from the group consisting of:
the plurality of measurement point candidates specified by the specifying process; and
the plurality of measurement point candidates extracted by the extraction process.

6. The information processing apparatus according to claim 5, wherein:
a display screen presented by the presentation process contains
a first graphical user interface that receives user input related to a position of the mobile object and
a second graphical user interface that receives user input related to a position of the external measurement apparatus; and
in the acquisition process, the at least one processor acquires the information pertaining to the relative position with reference to the user input received via the first graphical user interface and the user input received via the second graphical user interface.

7. The information processing apparatus according to claim 1, wherein the plurality of measurement point candidates specified by the specifying process include a pair of measurement point candidates that are provided parallel to at least one of axes of an orthogonal coordinate system in a case where the mobile object is in a vertical condition in the orthogonal coordinate system.

8. An information processing method, comprising:
acquiring, by at least one processor, a three-dimensional model of a mobile object; and
specifying, by the at least one processor with reference to the three-dimensional model, a plurality of measurement point candidates necessary for estimation of a posture of the mobile object.

9. A non-transitory storage medium storing therein a program to be executed by a computer, the program causing the computer to carry out:
an acquisition process of acquiring a three-dimensional model of a mobile object; and
a specifying process of specifying, with reference to the three-dimensional model, a plurality of measurement point candidates necessary for estimation of a posture of the mobile object.
